(19) United States
(12) Patent Application Publication
(10) Pub. No.: US 2004/0133462 A1
(43) Pub. Date: Jul. 8, 2004

(54) Computer system and method for producing integrated product forecasts

(76) Inventors: Claude D. Smith, Ladue, MO (US); William P. Cacheris, Wildwood, MO (US); Kevin S. Norell, O'Fallon, MO (US)

Correspondence Address: HARNESS, DICKEY, & PIERCE, P.L.C, 7700 BONHOMME, STE 400, ST. LOUIS, MO, 63105, US

(21) Appl. No.: 10/630,142

(22) Filed: Jul. 30, 2003

Related U.S. Application Data
(60) Provisional application No. 60/408,415, filed on Sep. 5, 2002.

(51) Int. Cl. G06F 17/60

(52) U.S. Cl. 705/10

(57) ABSTRACT

A computer system and method for producing an integrated product forecast from multiple preexisting product forecasts. Upon receiving parameters of an integrated product forecast desired by a user, data associated with preexisting product forecasts (such as pharmaceutical product forecasts) is preferably filtered to identify matching product forecasts. Data associated with the matching product forecasts is then used to produce the integrated product forecast, either in spreadsheet form or otherwise.

### CROSS-REFERENCE TO RELATED APPLICATION

This application claims priority to U.S. Provisional Application No. 60/408,415 filed Sep. 5, 2002, the entire disclosure of which is incorporated herein by reference.

### FIELD OF THE INVENTION

The present invention relates generally to financial forecasting and, in particular, to producing an integrated product forecast from multiple preexisting product forecasts.

### BACKGROUND OF THE INVENTION

Business professionals have long employed financial forecasting as a tool for predicting the success or failure of a particular product or product line. To this end, computer applications have been developed for generating product forecasts. One example of such an application is described in co-pending U.S. application Ser. No. 09/841,946 filed Apr. 25, 2001, the entire disclosure of which is incorporated herein by reference.

In many instances, a product forecast is produced (either manually or with the aid of a computer) for a specific product type, market and/or country. At some point, it often becomes necessary or advantageous to consolidate portions of individual forecasts into a single report or summary. Historically, this consolidation process is performed manually. For example, multiple forecasts in electronic form, each relating to one of several different products, may be emailed or otherwise provided to a specific person who then cuts and pastes data from the individual forecasts into a forecast summary. This process, however, suffers from many disadvantages, including the fact that it is time consuming and error prone.

As recognized by the inventors hereof, what is needed is a computerized tool for, among other things, producing integrated product forecasts from multiple preexisting product forecasts.

### SUMMARY OF THE INVENTION

In accordance with one aspect of the present invention, a computerized method of integrating preexisting product forecasts includes receiving from a user one or more parameters of an integrated product forecast desired by the user, the integrated product forecast relating to a plurality of products, identifying a plurality of preexisting product forecasts which match the one or more parameters received from the user, producing the integrated product forecast using data retrieved from the preexisting product forecasts which match the one or more parameters received from the user, and providing the produced integrated product forecast to the user.

According to another aspect of the invention, a computerized method of integrating preexisting pharmaceutical product forecasts in spreadsheet form includes receiving from a user via a computer network a plurality of parameters of an integrated product forecast desired by the user. The integrated product forecast relates to a plurality of pharmaceutical products, and the parameters received from the user are selected from the group consisting of product type, indication, therapeutic area, and country. The method further includes filtering data associated with preexisting pharmaceutical product forecasts in spreadsheet form using the parameters received from the user to thereby identify matching pharmaceutical product forecasts, producing the integrated product forecast using data retrieved from the matching pharmaceutical product forecasts, and providing the produced integrated product forecast to the user via the computer network.

According to a further aspect of the invention, a computerized method includes retrieving, in response to a user command, data associated with a preexisting product forecast in spreadsheet form, and transmitting the retrieved data through a computer network to a central database for storage.

According to still another aspect of the present invention, a computerized method includes receiving through a computer network forecast data associated with a plurality of preexisting product forecasts; storing the received forecast data in a central database; producing a log of the preexisting product forecasts having associated data stored in the central database; and providing the produced log to one or more users through the computer network.

Additional aspects of the invention, including computer systems and computer-readable media having instructions for performing the aforementioned methods, will be in part apparent and in part pointed out below.

### BRIEF DESCRIPTION OF THE DRAWINGS

FIG. 1 is a flow diagram of a computerized method for producing an integrated product forecast according to one embodiment of the present invention.

FIG. 2 is a block diagram of a computer network implementation of the present invention.

FIG. 3 is a flow diagram of a computerized method for posting preexisting forecast data to a central repository.

FIG. 4 is a flow diagram of a computerized method for managing preexisting forecast data in a computer network.

FIG. 5 illustrates several options provided within a custom menu of a spreadsheet application in one exemplary implementation of the present invention.

FIG. 6 illustrates a selection of an “upload forecast sheet(s)” option from the custom menu of FIG. 5.

FIG. 7 illustrates preexisting product forecast sheets for which data is to be uploaded to a central database.

FIG. 8 illustrates a user interface for prompting a user to input profile data for the data to be uploaded.

FIG. 9 illustrates uploading of forecast data, including related profile data, to a central database.

FIG. 10 illustrates a selection of a “forecast log” option from the custom menu of FIG. 5.

FIG. 11 illustrates a log of forecast data stored in the central database.

FIG. 12 illustrates a selection of the “generate forecast reports” option from the custom menu of FIG. 5.

FIG. 13 illustrates a user interface by which a user can input parameters of a desired integrated product forecast.

FIG. 14 illustrates an integrated product forecast as produced, in stacked bar or line graph format, in the exemplary implementation of the present invention.

FIG. 15 illustrates an integrated product forecast in tabular summary form.

### DETAILED DESCRIPTION OF PREFERRED EMBODIMENTS

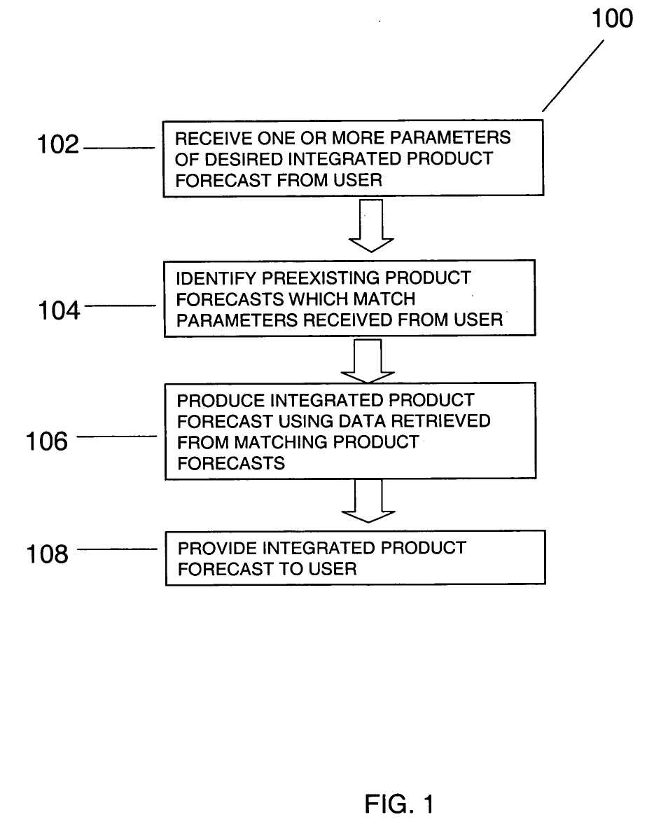

A computerized method of integrating preexisting product forecasts according to one embodiment of the present invention is illustrated by the flow diagram of FIG. 1 and indicated generally by reference character 100. As shown in step 102 of FIG. 1, the method 100 includes receiving from a user one or more parameters of an integrated product forecast desired by the user. This integrated product forecast preferably relates to several products, as further explained below. The method 100 further includes, in step 104, identifying preexisting product forecasts which match the one or more parameters received from the user and, in step 106, producing the integrated product forecast using data retrieved from the preexisting product forecasts which match the one or more parameters received from the user. In step 108, the produced integrated product forecast is provided to the user.

With further reference to step 102 of FIG. 1, a variety of means can be used for receiving the one or more parameters of the integrated product forecast desired by the user. For example, drop lists or dialogue boxes may be provided by which the user can select or specify certain parameters of interest. In fact, a variety of user input devices can be employed for this purpose, including a keyboard, computer mouse, touch screen, joystick, microphone and speech recognition functionality, etc. The one or more parameters may be received from the user via an independent computer device (e.g., a standalone desktop computer) executing the computerized method, or via a computer network to which the user's computer device is connected, as further explained below.

The one or more parameters received from the user preferably include at least one forecast metric for the integrated product forecast (identifying the type of integrated forecast to be produced, such as a forecast of sales, revenue, profit, etc.) as well as a time range (e.g., the start and end years for the integrated forecast). Although only a single forecast metric and time range are used to produce an integrated product forecast in some embodiments of the invention, integrated product forecasts involving multiple forecast metrics and multiple time ranges may also be produced without departing from the scope hereof. Default or fixed forecast metrics and time ranges may also be employed. Additional parameters received from the user may include product name, product type, product function or purpose, target customer name, target customer type, target geographic region, etc. The particular user-input parameters supported in any given implementation of the invention will depend in part upon the format of the preexisting forecast data from which the integrated product forecast is to be produced, the extent of user-customization desired in producing the integrated product forecast, etc.

As indicated above with reference to step 104 of FIG. 1, the one or more parameters received from the user are employed to identify preexisting product forecasts which match some or all of such parameters. In one embodiment, this is accomplished by searching or filtering forecast data associated with the existing product forecasts using the parameters received from the user. For example, the existing product forecasts may themselves be searched to identify those forecasts containing data corresponding to the input parameters. Alternatively (or additionally), the searched data can be data previously copied or otherwise extracted from preexisting product forecasts, as well as profile data (e.g., data characterizing the preexisting product forecasts) such as that collected directly from one or more users familiar with the preexisting product forecasts. The data to be searched may be centrally stored or, alternatively, may reside in various computer devices on a computer network.

In step 106 of FIG. 1, the integrated product forecast desired by the user is produced using data retrieved from preexisting product forecasts which match the one or more parameters received from the user. This data may be retrieved from the preexisting product forecasts before or after such forecasts are identified as matching the input parameters. For example, after identifying a preexisting product forecast as matching the input parameters, data can be retrieved (e.g., copied) directly therefrom. Alternatively, data can be retrieved from preexisting product forecasts and stored (e.g., in a central location) before the identifying step is performed (e.g., to facilitate searching of such data), and then subsequently retrieved from storage for use in producing the integrated product forecast (assuming such data is associated with a preexisting product forecast which matches the user-input parameters). In the case where the preexisting product forecasts are formatted similarly, data is preferably retrieved from predefined regions of the preexisting forecasts (e.g., from one or more predefined ranges of a spreadsheet forecast). Alternatively, user commands, software logic, or other means may be employed for determining which data (if not all) should be retrieved from preexisting forecasts for use in producing the integrated product forecast.

The retrieved data is then processed and manipulated as necessary to produce the integrated product forecast desired by the user. Preferably, data relating to a particular forecast metric (e.g., projected sales) and for a particular time period in one preexisting product forecast is combined with like data from other preexisting forecasts. For example, projected sales data can be extracted from each preexisting product forecast which matches the parameters received from the user, and then reproduced, summarized and/or totaled within the integrated product forecast. The integrated data can be presented in any desired format, including in narrative form, tables, charts, etc.

The integrated product forecast produced in box 106 of FIG. 1 can be provided to the user, as indicated in step 108 of FIG. 1, in a variety of ways. For example, the integrated forecast may be displayed to the user via a computer display device, provided to the user in hard or soft copy form, etc.

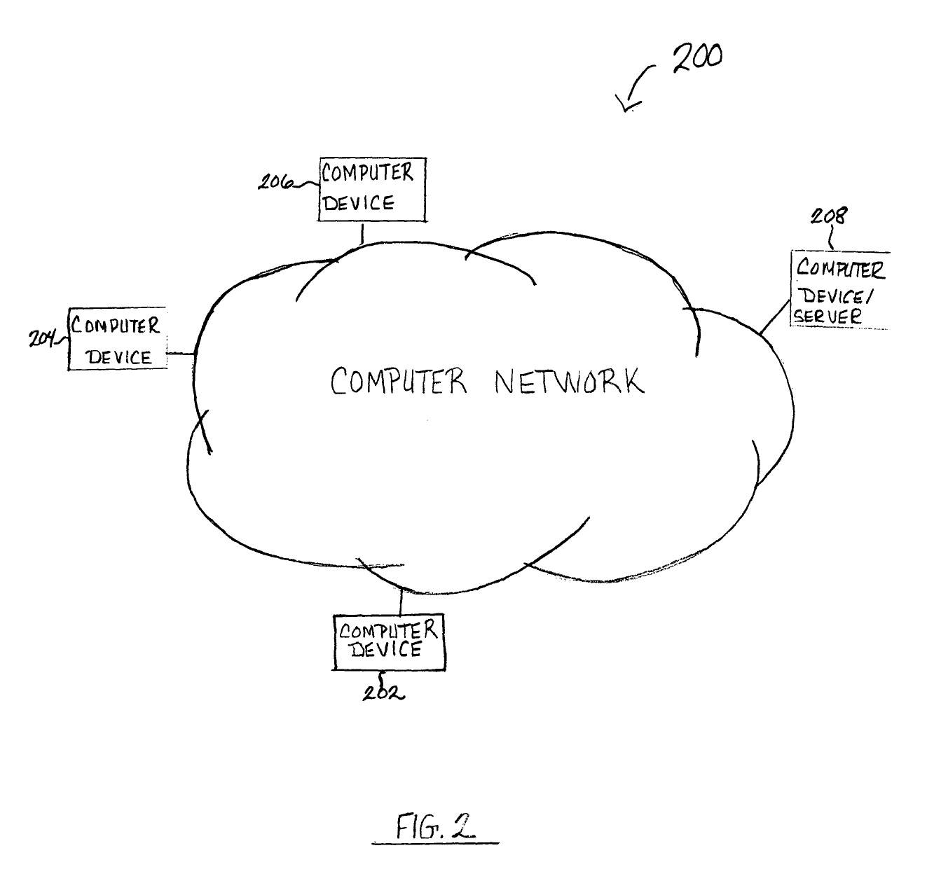

As noted above, the present invention can be implemented using a single computer device configured for independent operation. Alternatively, the invention can be implemented through a computer network 200, as illustrated generally in FIG. 2. Through a network implementation, multiple users of the computer network 200 may readily generate integrated product forecasts via their associated computer devices 202-208. Further, implementing the present invention via a computer network allows a user at one node of the network to produce an integrated product forecast not only from preexisting forecast data stored locally on that user's computer device (if applicable), but also from preexisting forecast data residing elsewhere on the network 200. For example, a user of the computer device 202 may input parameters of an integrated product forecast desired by that user. These parameters can then be used to search one or more of the other computer devices 204-208 located on the network for preexisting product forecasts which match the input parameters. The integrated product forecast can then be produced, by the computer device 202 or by another one of the computer devices 204-208 (such as the server 208), using data retrieved from the matching product forecasts. The produced integrated product forecast may then be provided to the user via the computer device 202.

The computer network 200 shown in FIG. 2 may represent a local area network (LAN), thus permitting, for example, multiple users in an office environment to readily produce integrated product forecasts from preexisting forecast data residing anywhere (or at one or more specific locations) on the network. The computer network 200 may also represent a wide area network (e.g., the Internet), thereby permitting users anywhere on the network (e.g., including in various cites, states and/or countries) to readily produce integrated product forecasts from preexisting forecast data residing elsewhere on the network. As will be apparent to those skilled in the art, the computer network 200 may also represent a combination of networks such as, e.g., multiple LANs connected to one another through a wide area network (e.g., the Internet). The computer devices 202-208 may include desktop computers, file servers, database servers, Web servers, laptop or notebook computers, handheld computers including personal digital assistants (PDAs), and any other presently known or future computer device capable of accessing the network 200. Although only four computer devices 202-208 are shown illustratively in FIG. 2, it should be understood that the computer network 200 may include a lesser or greater number of such devices.

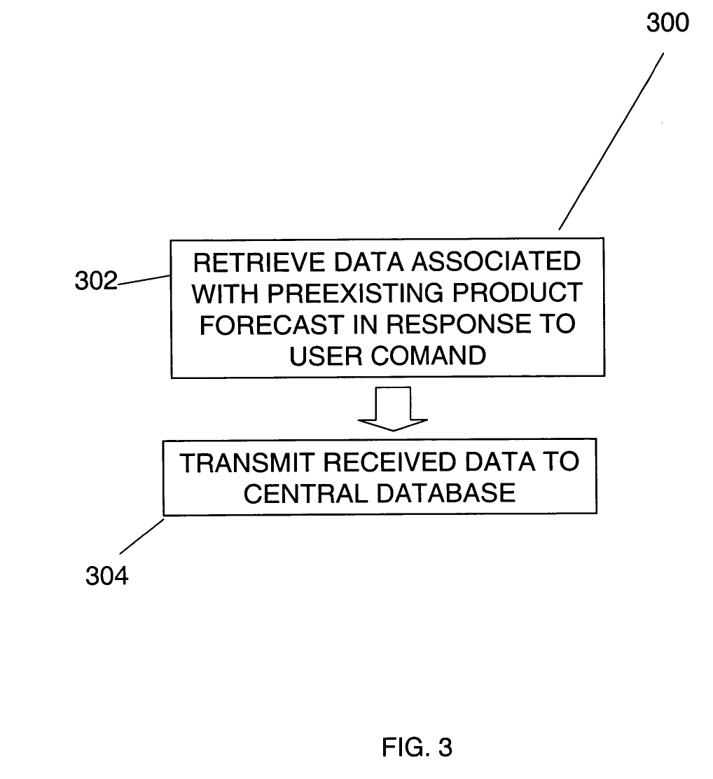

In one embodiment, the invention is implemented via a computer network, and integrated product forecasts are produced, at least in part, from preexisting forecast data that is stored in a central repository, such as a file or database server. A computerized method 300 for posting preexisting forecast data to the central repository is illustrated generally by the flow diagram of FIG. 3. Beginning with step 302 of FIG. 3, the method includes retrieving, in response to a user command, data associated with a preexisting product forecast. The retrieved data is then transmitted through the computer network to a central database for storage, as indicated in step 304 of FIG. 3. As should be apparent, the method 300 may be performed with respect to multiple preexisting product forecasts, as well as by multiple users, so as to transmit forecast data residing at various locations on the computer network to a central database for storage and convenient access thereafter.

With further reference to step 302 of FIG. 3, the retrieving may be performed by retrieving an electronic file which contains the associated data, such as an electronic file which itself constitutes the preexisting product forecast, or an electronic file into which the associated data was previously copied. Alternatively, the associated data may be retrieved from one or more predefined regions of the preexisting product forecast. In the case where the preexisting product forecast is in spreadsheet form, the predefined regions may be predefined ranges of the spreadsheet, as noted above.

Although not depicted in FIG. 3, the method 300 may also include receiving from a user profile data relating to the preexisting product forecast. In such a case, the transmitting step 304 preferably includes transmitting the received profile data to the central database for storage.

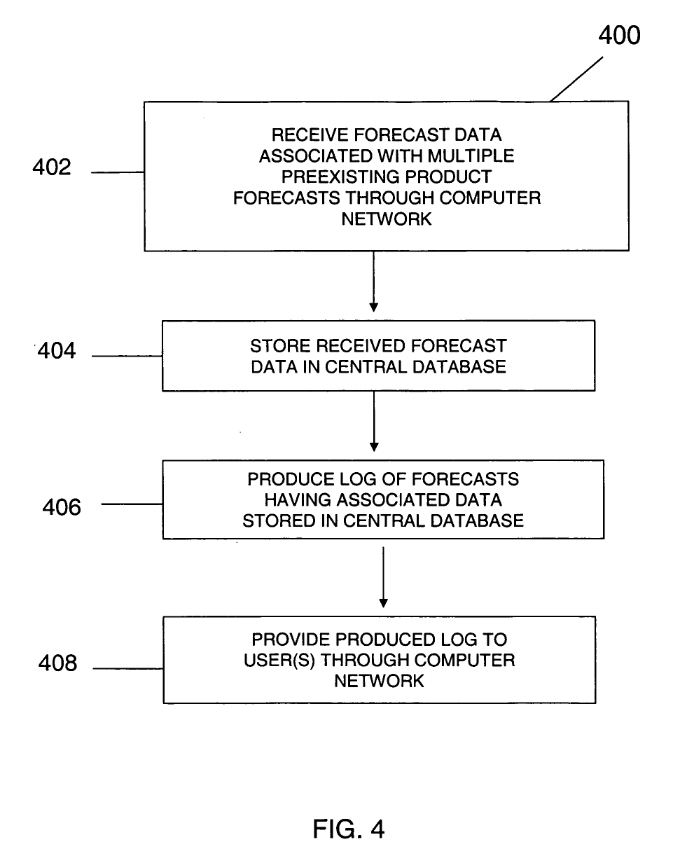

A computerized method 400 for managing preexisting forecast data in a computer network is illustrated generally by the flow diagram of FIG. 4. As shown in step 402 thereof, the method 400 includes receiving through the computer network forecast data associated with multiple preexisting product forecasts. The received forecast data is then stored in a central database, as indicated in step 404. The method 400 further includes producing a log of the preexisting product forecasts having associated data stored in the central database, as indicated in step 406, and providing the produced log to one or more users through the computer network as indicated in step 408. In this manner, users can readily identify the preexisting forecast data which is stored in the central database by referencing the log. The method may also include deleting preexisting forecast data from the central database in response to a user request, which may be made via the log, as well as revising the log to remove therefrom one or more preexisting forecasts for which associated data was deleted.

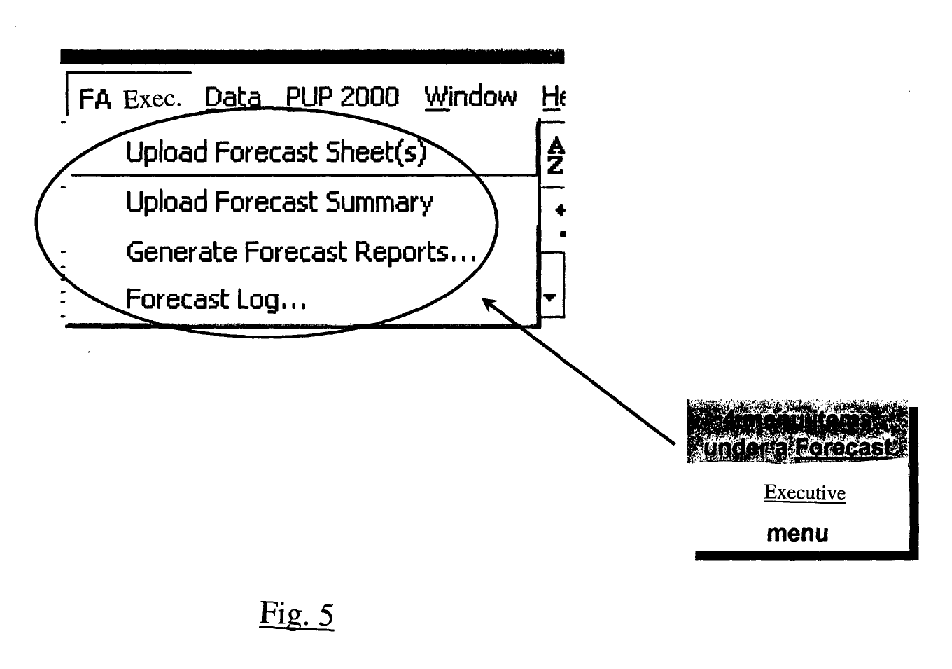

One exemplary implementation of the present invention within a network environment will now be described with reference to FIGS. 5-14. While this particular implementation utilizes the Microsoft Excel spreadsheet application and product forecasts embodied in Excel spreadsheets, it should be understood that the teachings of the present invention are far from so limited.

As shown in FIG. 5, a custom “FA Exec” menu is provided within the Excel spreadsheet application. Included within this custom menu are “upload forecast sheet(s)”, “upload forecast summary”, “generate forecast reports”, and “forecast log” options.

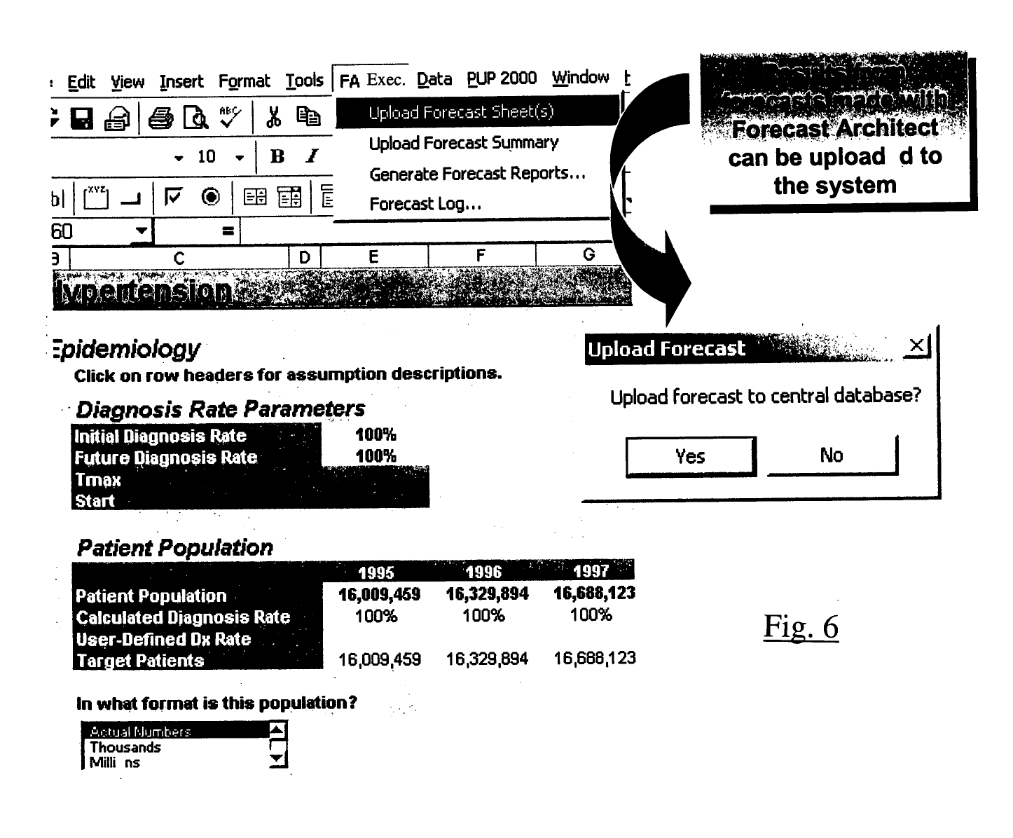

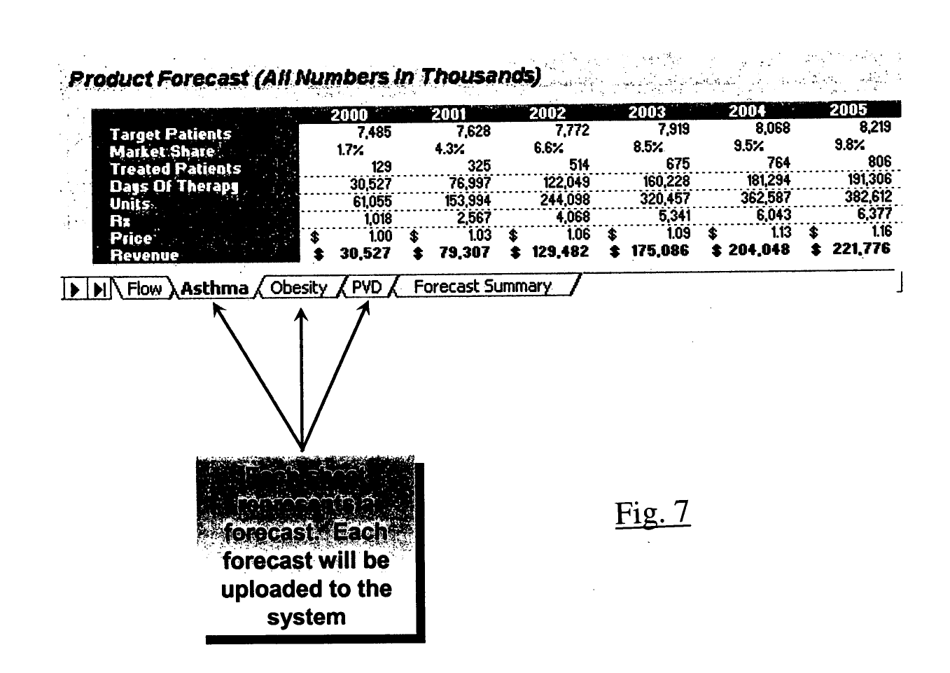

Initially, the user preferably opens or creates a new product forecast using the Excel spreadsheet application and the product forecasting application described in applicant's co-pending patent application noted above. Thereafter, the user can select the “upload forecast sheet(s)” option from the custom menu item, as shown in FIG. 6, to initiating posting or uploading of data associated with one or more sheets of a preexisting product forecast (i.e., the opened or newly created product forecast, as illustrated in FIG. 7) to a central repository (e.g., a database). Alternatively, the user can select the “upload forecast summary” option to initiate posting or uploading of data from a preexisting summary of multiple, individual forecasts.

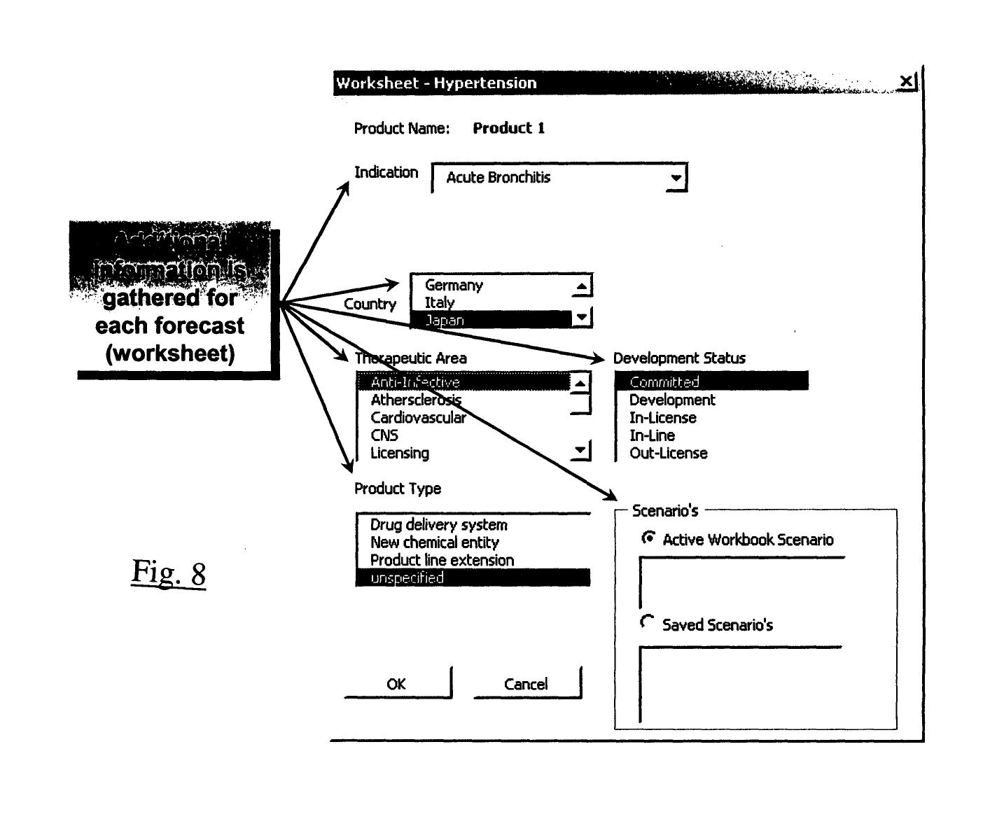

Preferably, the system prompts the user for profile data related to the product forecast data to be uploaded. In this exemplary implementation, which is specifically directed at pharmaceutical product forecasts, the requested profile data includes the name of the forecasted product as well as the corresponding indication, therapeutic area, product type, country, and development status, as shown in FIG. 8. In the case where multiple scenarios exist for a preexisting forecast, the requested profile data may further include data identifying one or more of the multiple scenarios (such as the scenario actively displayed on the user's computer, or an inactive saved scenario).

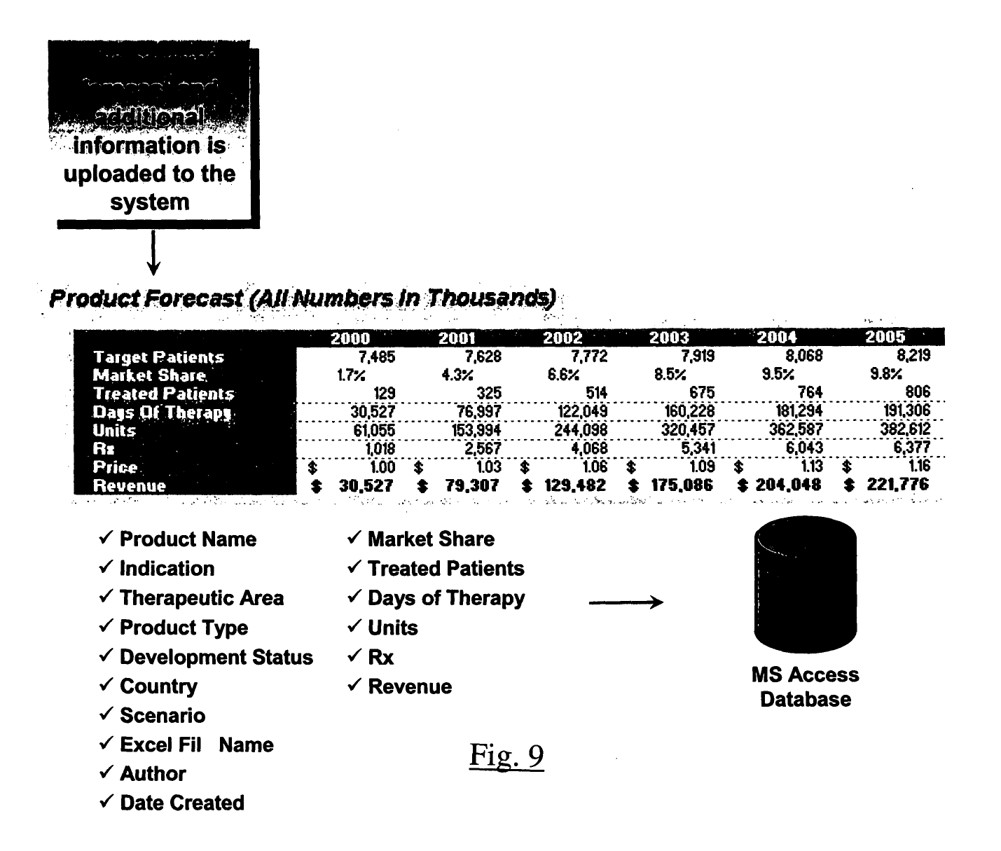

The collected profile data as well as forecast data from predefined regions of the preexisting product forecast (e.g., target patient, market share, treated patients, days of therapy, units, Rx, price and revenue data) are then uploaded to a central database, as illustrated generally in FIG. 9. In this exemplary implementation, the central database is an MS Access database.

As should be apparent, this process can be performed for each of numerous product forecasts (including any associated summaries and scenarios), and by multiple users on the computer network, to facilitate uploading of data for numerous product forecasts to the central database.

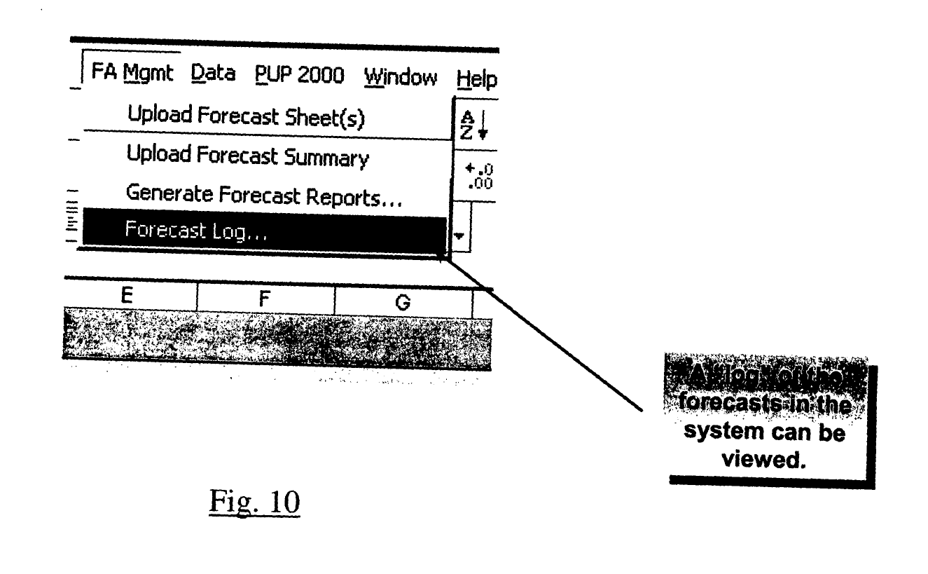

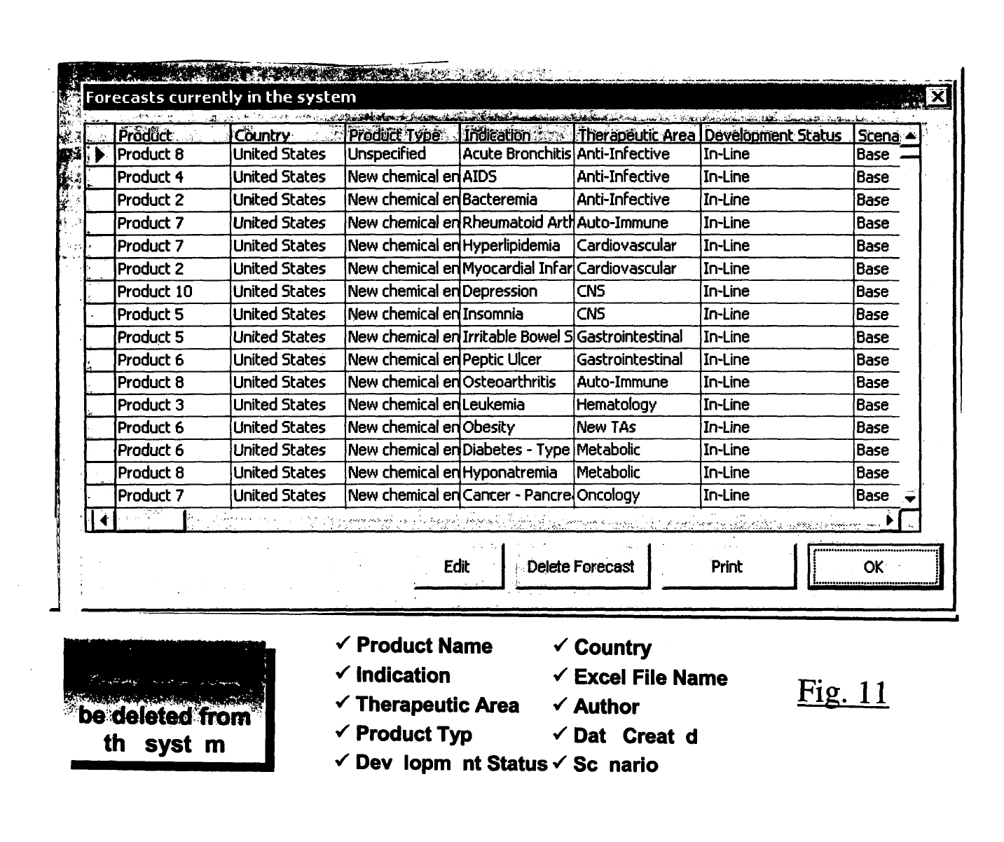

To facilitate management of the forecast data stored in the central database, the “forecast log” option is provided in the custom menu, as noted above. Selecting this item by a user, as illustrated generally in FIG. 10, prompts the system to display a log of the forecast data stored in the central database, including corresponding profile data, as shown in FIG. 11. Preferably, users can delete forecast data from the central database by simply selecting such data in the log and then selecting a delete function (such as a delete key on the user device or the “delete forecast” button shown in FIG. 11).

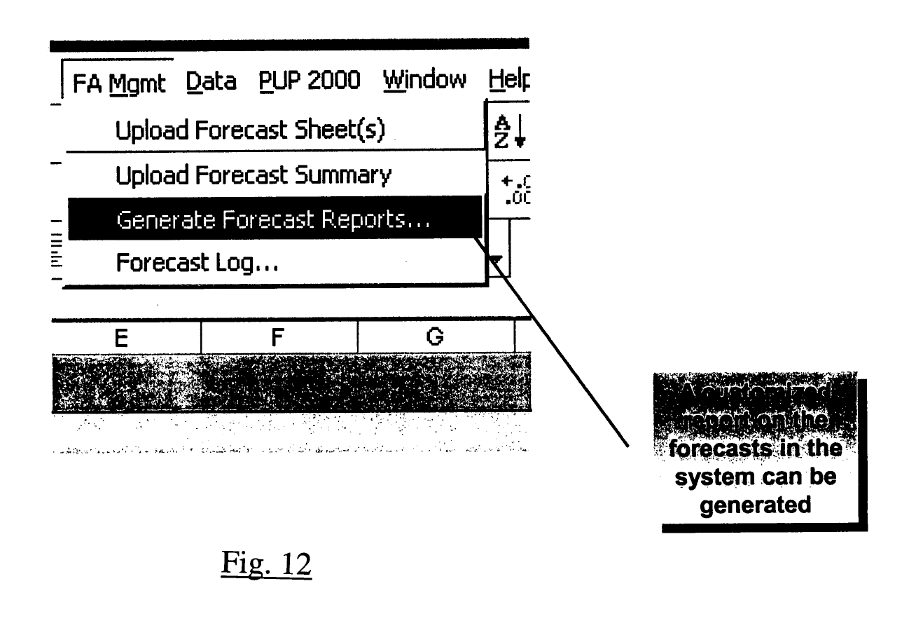

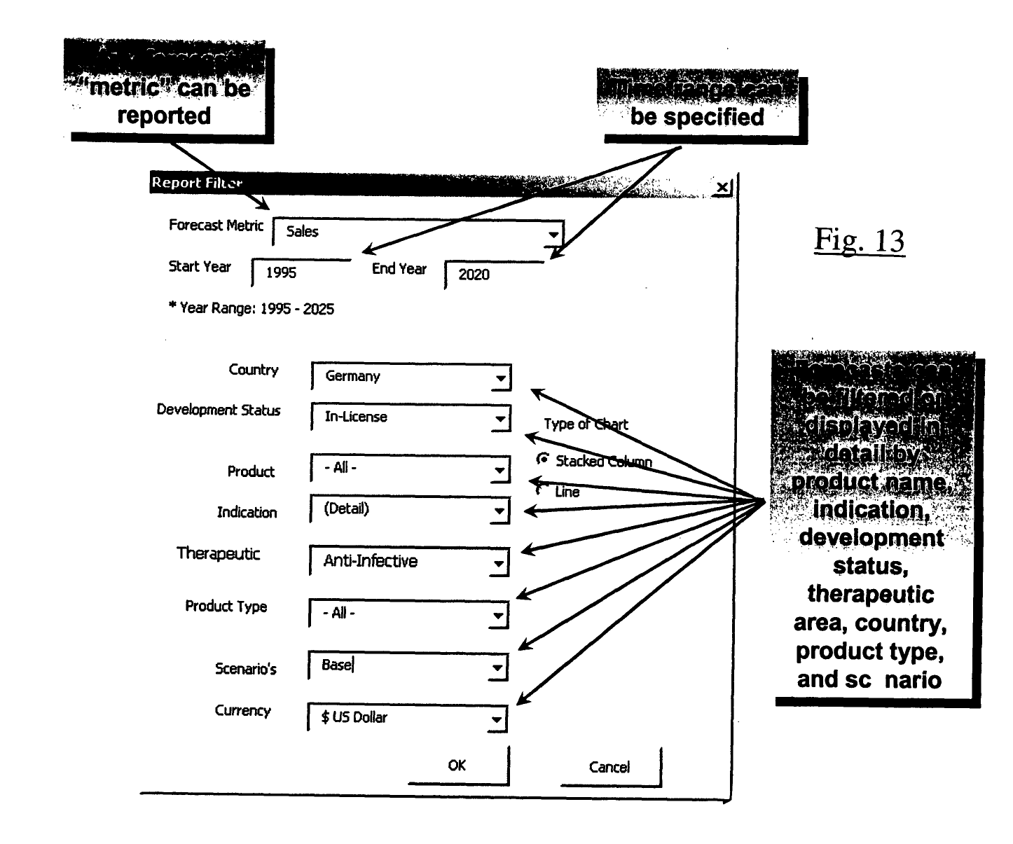

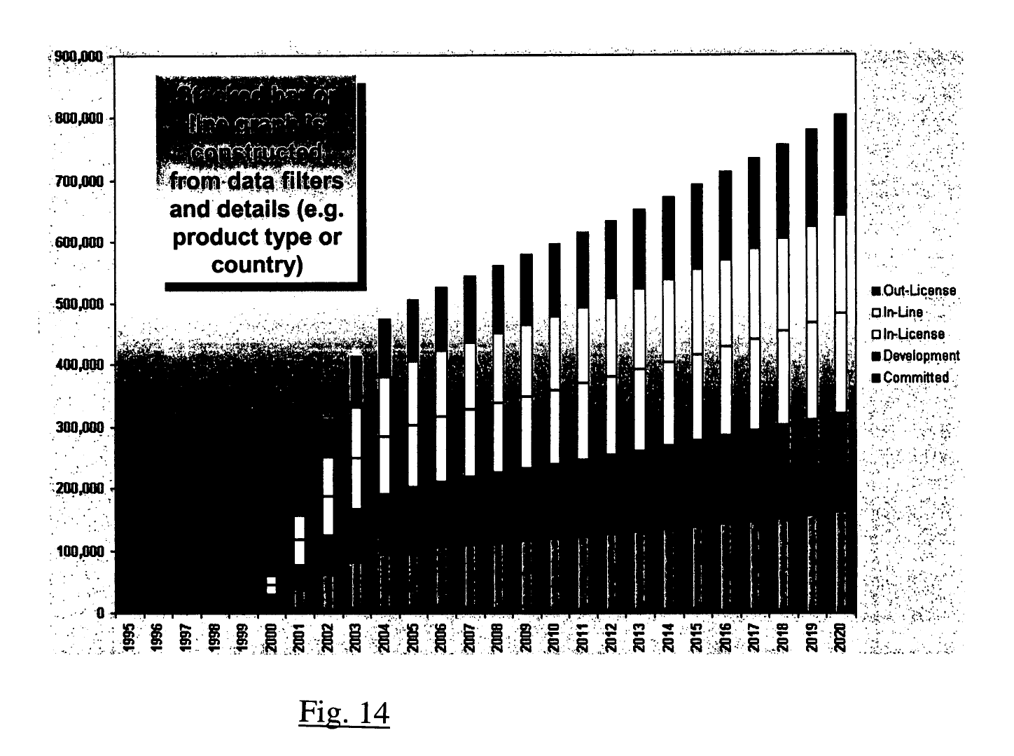

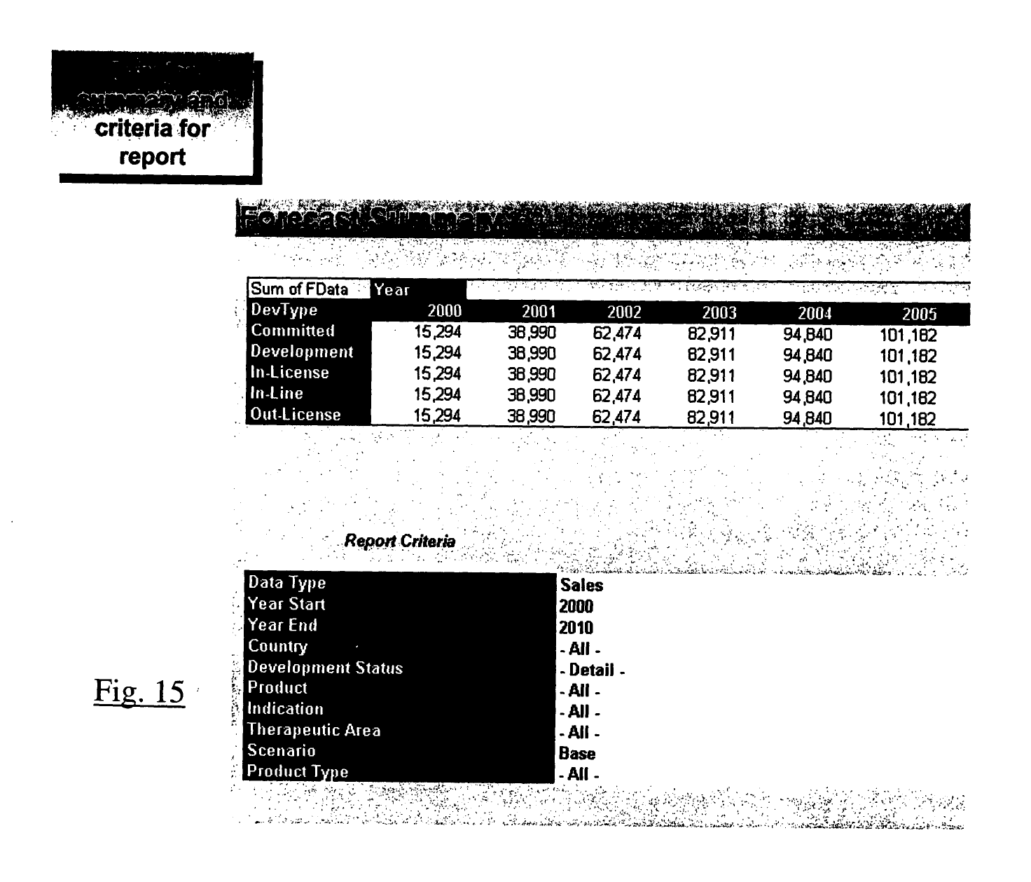

Once forecast data is uploaded to the central database, users on the network can initiate creation of integrated product forecasts from such data by selecting the “generate forecast reports” option on the custom menu item, as illustrated generally in FIG. 12. In response to this selection, the system displays a user interface, as shown in FIG. 13, which prompts the user to define the integrated product forecast desired by the user in terms of a forecast metric (e.g., forecasted sales), start and end years, as well as the product name, indication, development status, therapeutic area, country, scenario and/or product type of interest to the user. Additionally, the user can specify a format for the desired integrated product forecast (e.g., a stacked column or line chart) and the currency units to be employed. The system then uses the input parameters to filter the forecast data stored in the central database so as to identify forecast data matching the user-input parameters. This matching data is then retrieved (e.g., copied) from the central database and processed as necessary to produce the integrated product forecast desired by the user. One example of such an integrated product forecast, presented in the form of a stacked bar or line graph, is illustrated in FIG. 14. The system may also produce a tabular summary and the criteria used in producing the integrated product forecast, as shown in FIG. 15.

As used herein, the term “pharmaceutical products” includes biotechnology products intended for medicinal or therapeutic use.

When introducing elements or features of the present invention or preferred embodiments, the articles “a,” “an,” “the,” and “said” are intended to mean that there are one or more of such elements or features. The terms “comprising,” “including,” and “having” are intended to be inclusive and mean there may be elements or features in addition to those noted.

As various changes could be made in the above constructions without departing from the scope of the invention, it is intended that all matter contained in the above description or shown in the accompanying drawings shall be interpreted as illustrative and not in a limiting sense.

What is claimed:

1. A computerized method of integrating preexisting product forecasts, the method comprising:
receiving from a user one or more parameters of an integrated product forecast desired by the user, the integrated product forecast relating to a plurality of products;
identifying a plurality of preexisting product forecasts which match the one or more parameters received from the user;
producing the integrated product forecast using data retrieved from the preexisting product forecasts which match the one or more parameters received from the user; and
providing the produced integrated product forecast to the user.

2. The computerized method of claim 1 wherein the one or more parameters received from the user include a forecast metric for the integrated product forecast.

3. The computerized method of claim 2 wherein the one or more parameters received from the user include a time range for the integrated product forecast.

4. The computerized method of claim 2 wherein the plurality of products are pharmaceutical products, and wherein the forecast metric is selected from the group consisting of sales, market share, units, and prescriptions.

5. The computerized method of claim 4 wherein the one or more parameters received from the user further include parameters selected from the group consisting of product name, product type, indication, therapeutic area, and country.

6. The method of claim 1 wherein receiving includes receiving the one or more parameters from the user via one of a local area network and a wide area network.

7. The method of claim 1 wherein the preexisting product forecasts are in spreadsheet form, and wherein producing includes producing the integrated product forecast in spreadsheet form.

8. The method of claim 7 wherein the preexisting product forecasts were produced using a computer spreadsheet application, and wherein producing includes producing the integrated product forecast as a portable electronic file using said computer spreadsheet application.

9. The method of claim 1 wherein identifying includes filtering data associated with the preexisting product forecasts using the one or more parameters received from the user.

10. The method of claim 9 wherein the data associated with the preexisting product forecasts includes profile data input directly by one or more users.

11. A computer-readable medium having computer-executable instructions for performing the method of claim 1.

12. A computerized method of integrating preexisting pharmaceutical product forecasts in spreadsheet form, the method comprising:
receiving from a user via a computer network a plurality of parameters of an integrated product forecast desired by the user, the integrated product forecast relating to a plurality of pharmaceutical products, the parameters received from the user being selected from the group consisting of product type, indication, therapeutic area, and country;
filtering data associated with preexisting pharmaceutical product forecasts in spreadsheet form using the parameters received from the user to thereby identify matching pharmaceutical product forecasts;
producing the integrated product forecast using data retrieved from the matching pharmaceutical product forecasts; and
providing the produced integrated product forecast to the user via the computer network.

13. The computerized method of claim 12 wherein the computer network is a local area network.

14. A computer-readable medium having computer-executable instructions for performing the method of claim 13.

15. The computerized method of claim 12 wherein the computer network is a wide area network.

16. A computer-readable medium having computer-executable instructions for performing the method of claim 15.

17. The computerized method of claim 12 wherein the preexisting pharmaceutical product forecasts in spreadsheet form were produced using a computer spreadsheet application, and wherein producing includes producing the integrated product forecast using said computer spreadsheet application.

18. A computerized method comprising:
retrieving, in response to a user command, data associated with a preexisting product forecast in spreadsheet form; and
transmitting the retrieved data through a computer network to a central database for storage.

19. The computerized method of claim 18 wherein retrieving includes retrieving an electronic file comprising said data, and transmitting includes transmitting the retrieved electronic file to the central database for storage.

20. The computerized method of claim 18 wherein retrieving includes retrieving said data from one or more predefined regions of the preexisting product forecast.

21. The computerized method of claim 18 wherein the computer network is one of a local area network and a wide area network.

22. The computerized method of claim 18 further comprising receiving from a user profile data relating to the preexisting product forecast, and wherein transmitting includes transmitting the received profile data to the central database for storage.

23. The computerized method of claim 22 further comprising prompting the user to provide said profile data.

24. The computerized method of claim 23 wherein prompting includes prompting the user to provide profile data selected from the group consisting of country, indication, product type, and therapeutic area.

25. The computerized method of claim 18 further comprising storing the transmitted data in the central database.

26. The computerized method of claim 18 wherein the preexisting product forecast is a preexisting pharmaceutical product forecast.

27. A computer-readable medium having computer-executable instructions for performing the computerized method of claim 18.

28. A computerized method comprising:
receiving through a computer network forecast data associated with a plurality of preexisting product forecasts;
storing the received forecast data in a central database;
producing a log of the preexisting product forecasts having associated data stored in the central database; and
providing the produced log to one or more users through the computer network.

29. The computerized method of claim 28 further comprising receiving through the computer network a user request to delete data associated with one or more of the preexisting product forecasts included in said log, and deleting such data from the central database.

30. The computerized method of claim 29 wherein said user request is made via the log provided through the computer network.

31. The computerized method of claim 29 further comprising revising the log to remove therefrom the one or more preexisting product forecasts for which associated data was deleted from the central database in response to the user request.
